(19) United States
(12) Patent Application Publication
(10) Pub. No.: US 2011/0240693 A1
(43) Pub. Date: Oct. 6, 2011

(54) BABY CARRIER WITH TIE STRAPS

(76) Inventors: Michael A. Parness, Lake Hopatcong, NJ (US); Sara Lighthall, San Diego, CA (US); Melissa Ward, Santee, CA (US)

(21) Appl. No.: 13/075,649

(22) Filed: Mar. 30, 2011

Related U.S. Application Data
(60) Provisional application No. 61/319,153, filed on Mar. 30, 2010.

(51) Int. Cl. A61G 1/00

(52) U.S. Cl. 224/160

(57) ABSTRACT

An infant carrying apparatus is provided. The apparatus includes a main panel having an upper end portion, a lower end portion and a pair of opposing side portions. A pair of shoulder straps are connected to the main panel adjacent the upper end portion at a respective side portion and a pair of waist straps are connected to the main panel adjacent the lower end portion at a respective side portion. A pair of loops are also connected to the main panel at respective side portions thereof. The shoulder straps may be wrapped around a wearer's body and fed through the loops to secure the carrier to the wearer, and to define adjustable leg hole openings for the child's leg. The shoulder straps, main panel, and waist straps minimize the risk of the child falling out of the carrier through the leg openings.

### CROSS-REFERENCE TO RELATED APPLICATIONS

This application claims the benefit of U.S. Provisional Application No. 61/319,153, filed Mar. 30, 2010.

### STATEMENT RE: FEDERALLY SPONSORED RESEARCH/DEVELOPMENT

Not Applicable

### BACKGROUND OF THE INVENTION

1. Technical Field of the Invention

The present disclosure relates generally to infant carrying and support devices. More particularly, the present disclosure relates to an infant carrier having shoulder straps which wrap around a parent, with the ends of the shoulder straps being passed through a respective loop formed on the carrier to define an adjustable leg hole opening which secures the child within the carrier to minimize the risk of the child falling from the carrier.

2. Description of the Related Art

It is common practice for parents and other caregivers to carry infants and toddlers, and there are a variety of well-known devices suitable to this end. Such infant-carrying devices include carriages, strollers, pushchairs, and car seats, which are separate units particularly configured for holding the infant or toddler independent of the parent/caregiver adult. The adult, in turn, holds and transports the device with handles and other attachments thereof. Alternatively, there are devices known in the art configured to be worn by the adult for on-the-body carrying of the infant or toddler, including slings, wraps, pouches, and backpack-like shoulder strap devices.

Historically, the practice of carrying infants and toddlers on the body of the parent/caregiver is more prevalent in traditional cultures, and indeed, most basic slings and wraps are derivations of long-established designs originating therefrom. In industrialized cultures, however, it was deemed to be detrimental to the development of the child to experience too much physical contact with the parents or caregivers. Thus, carrying infants and toddlers in a manner that would entail the same typically was, and remains, relatively uncommon. However, these views are increasingly being challenged on the basis that there are numerous developmental benefits to the child. Additionally, there appear to be immediate benefits to the parent/caregiver, including the freedom to use both hands while monitoring and caring for the child being carried. Thus, care may be provided to other children simultaneously, strain and fatigue on the arms, back, and shoulders may be reduced, and household chores may be completed while easily monitoring the child. Moreover, cumbersome and bulky strollers need not be deployed in potentially dangerous places, such as along crowded city sidewalks and public transportation systems. Therefore, on-the-body carrying of children is growing in popularity.

As noted, there are a number of basic configurations for infant carriers suitable for on-the-body carry, including slings, wraps, and shoulder strap carriers. Though simpler in construction, slings and wraps are not as popular as infant carriers that incorporate shoulder straps, due in part to the difficulty associated with proper wear. Among infant carriers with shoulder straps, there are those with frames fashioned after conventional backpacks. Accordingly, such framed carriers typically support the child on the back of the wearer. Also, there are frameless or soft-sided carriers that support the child on the front or chest of the wearer such as that contemplated in U.S. Pat. No. 6,763,983 to Norman, as well as those that support the child on the hip of the wearer such as that contemplated in U.S. Pat. No. 5,813,580 to Fair.

There are a number of positions and orientations in which the child may be carried, each being appropriate for different circumstances. For example, where there is a need for increased monitoring, the child may be carried on the front of, and facing backwards to, the parent or caregiver. Further, while completing errands, or otherwise participating in activities that takes the child out of the home, a greater degree of interaction with the surrounding environment may be offered by carrying the child in the front of, and facing forward along the same perspective as, the parent or caregiver. Where there is a significant potential for exposing the child to frontal hazards, it may be more appropriate to carry the child on the back, such that the body of the parent/caregiver acts as a shield. Conventional infant carriers incorporate features that accommodate both modes of carry.

Providing proper support for the carried child is an important design consideration in light of a typical child's diminutive size and frailty. If accidentally dropped from a normal operating height with the carrier being worn by an average adult, the child may be significantly injured. Many carriers include openings along the sides to accommodate a child's legs. A primary concern is that the child may fall out of the carrier through the opening in the sides. As an expression of this concern for safety, various standards are promulgated by governmental entities, international industry organizations, and the like, and manufacturers of infant carriers and other child-oriented devices develop products that conform thereto.

Accordingly, there is a need in the art for infant carrying devices with enhanced safety features, particularly in relation to the size of the leg openings formed within the infant carrying device.

### BRIEF SUMMARY OF THE INVENTION

In accordance with one embodiment of the present invention, an adjustable, easy to use, wrap-style infant carrying apparatus is provided. The infant carrier may be worn by a parent or caregiver to hold the child in one of several different holding positions or holding techniques. To ensure the safety of the child, the infant carrier includes an adjustable leg hole opening which minimizes the risk that the child will fall out of the infant carrier through the leg hole opening. In this regard, the leg hole opening may be adjusted to a smaller size for a smaller child, and a larger size for a larger child.

The infant carrier includes a main panel having an upper end portion, a lower end portion and a pair of opposing side portions. The main panel additionally includes a pair of loops, with each loop being disposed adjacent a respective one of the pair of side portions. A pair of shoulder straps extend from the main panel adjacent the upper end portion thereof. Each shoulder strap extends from a respective one of the pair of side portions. The carrier additionally includes a pair of waist straps extending from respective ones of the pair of side portions, adjacent the lower end portion. The shoulder straps and waist straps may be wrapped, and twisted in different configurations to accommodate various holding positions and holding techniques. Importantly, each shoulder strap is eventually fed through the loops to define the leg hole opening and to secure the child within the carrier.

The preset invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of an infant carrier with tie straps, constructed in accordance with an embodiment of the present invention, the carrier being depicted in one exemplary mode of use on the chest of a wearer;

FIG. 2 is a front view of the infant carrier shown in FIG. 1 in an untied, non-operative state;

FIGS. 3-10 depict an exemplary sequence of steps for attaching the infant carrier to a caregiver in a chest covering, “baby facing in” position;

FIGS. 11-13 depict exemplary steps which may be used to facilitate the attachment of the infant carrier to a caregiver in a chest covering, “baby facing out” position; and

FIGS. 14-21 depict an exemplary sequence of steps for attaching the infant carrier to a caregiver in a “baby on back” position.

Common reference numerals are used throughout the drawings and the detailed description to indicate the same elements.

### DETAILED DESCRIPTION OF THE INVENTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

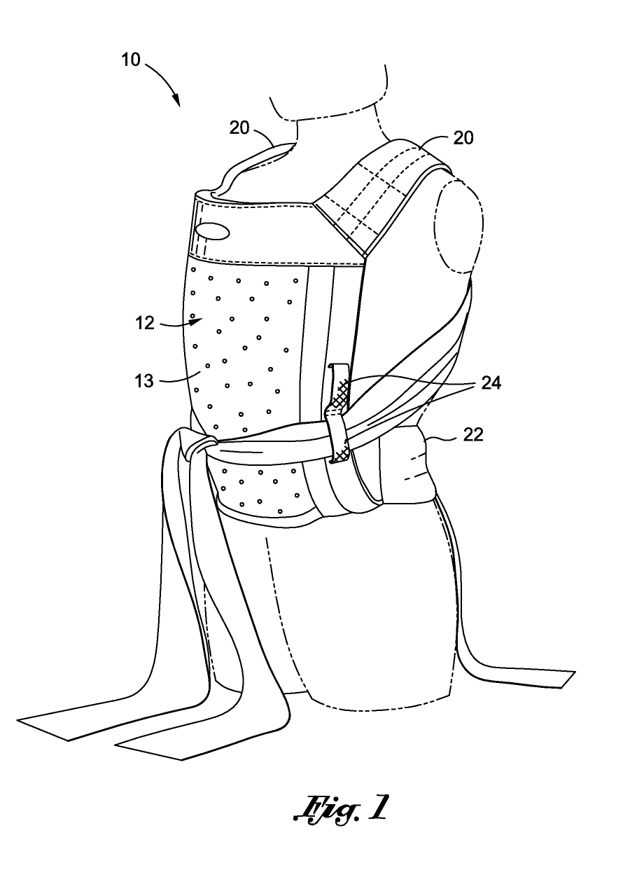

Referring now to FIGS. 1 and 2, there is depicted an infant carrier 10 configured to be wearable by a parent or caregiver (collectively referred to herein as “parent”) to carry an infant. The infant carrier 10 employs a unique tie design to achieve infant security, adjustability, ease-of-use and comfort for both the infant and the wearer. The tie design reduces the need for buckles, and simplifies fastening, while at the same time maintaining a safe a secure device for carrying an infant. The infant carrier 10 depicted in FIG. 1 is shown in an operative, fastened configuration oriented upon the chest of a wearer. Conversely, the infant carrier 10 depicted in FIG. 2 is shown in a non-operative, unfastened configuration.

Various aspects of the infant carrier 10 are directed toward satisfying the standards set forth by the American Society for Testing and Materials (ASTM), particularly with regard to the standards pertaining to leg hole openings in infant carriers. There is an industry wide concern that a leg hole opening may be so large that a child may fall out of the infant carrier through the leg opening. There is a desire that the leg opening is adjustable in nature to comfortably fit around the child's leg, while at the same time securing the child within the carrier to minimize the risk of falling through the leg opening.

The infant carrier 10 includes a main panel 12 defining an upper end portion 14, a lower end portion 16, and opposing lateral side edges 18 extending between the upper end portion 14 and the lower end portion 16. The main panel 12 additionally defines an outer surface 13, which faces outwardly (away from the wearer) during use, and an opposing inner surface 15 (See FIG. 3), which faces inwardly (toward the wearer) during use. The outer surface 13 may include decorative fabric to create an aesthetic appearance. The exemplary panel 12 depicted in the figures defines a generally rectangular shape, however, other shapes (i.e., trapezoidal, oval, etc.) may be used without departing from the spirit and scope of the present invention.

A pair of shoulder tie-straps 20 are connected to the main panel 12 adjacent the upper end portion 14 thereof. Each shoulder strap 20 extends generally diagonally from the main panel 12 relative to a respective one of the pair of side edges 18. In addition, a pair of waist tie-straps 22 are connected to the main panel 12 adjacent the lower end portion 16 thereof. Each waist strap 22 extends generally perpendicularly from the panel 12 relative to a respective one of the pair of side edges 18. Both the shoulder straps 20, and waist straps 22 are fabricated to be of a prescribed length to facilitate the wrapping and tying thereof in a manner described below, and are fabricated from a material strong enough to facilitate the various holding techniques also described below.

The infant carrier 10 additionally includes loops 24 connected to the panel 12 adjacent the side edges 18 thereof. As will be discussed in more detail in the following sections, the loops 24 are operative to receive the shoulder straps 20 to define a portion of the leg hole opening which the infant's leg passes through. The carrier 10 illustrated in the drawings includes two pairs of loops 24 connected to the panel 12, with each pair being connected adjacent a respective one of the pair of opposing side edges 18. Each pair of loops 24 is arranged in a generally vertical orientation when viewed from the perspective shown in FIG. 2. Although the exemplary embodiment depicts two loops 24 adjacent each side edge 18, it is understood other embodiments of the carrier 10 may include fewer than two loops 24, or more than two loops 24 adjacent each side edge 18.

The carrier 10 additionally includes an adjustment strap 26 (see FIG. 2) connected to the outer surface 13 of the panel 12. In the carrier 10, the adjustment strap 16 extends generally perpendicularly between the side edges 18 and across the panel 12 adjacent the lower end portion 16 of the panel 12. The adjustment strap 26 is used to configure the carrier 10 for use in one or more of the holding techniques described below.

The infant carrier 10 may be worn in various positions on the parent, and may accommodate various infant holding techniques. The following discussion, and remaining figures, relate to the various techniques of using the infant carrier 10.

A comforting position for both the parent and the child is depicted in FIGS. 3-10, and will be referred to herein as the “baby facing in” position. In this position, the infant carrier 10 is positioned over the parent's chest to receive the child with the child's head facing the parent, and the child's legs straddling the parent. This position may be comforting for the parent, especially when the child is very young, because it allows the parent to see the child. This position may also be comfortable for the child because it may create security for the child by holding the child close to the parent in a position which allows the child to see the parent. This position is also commonly recommended to be used until the child is strong enough to independently hold his/her head upright.

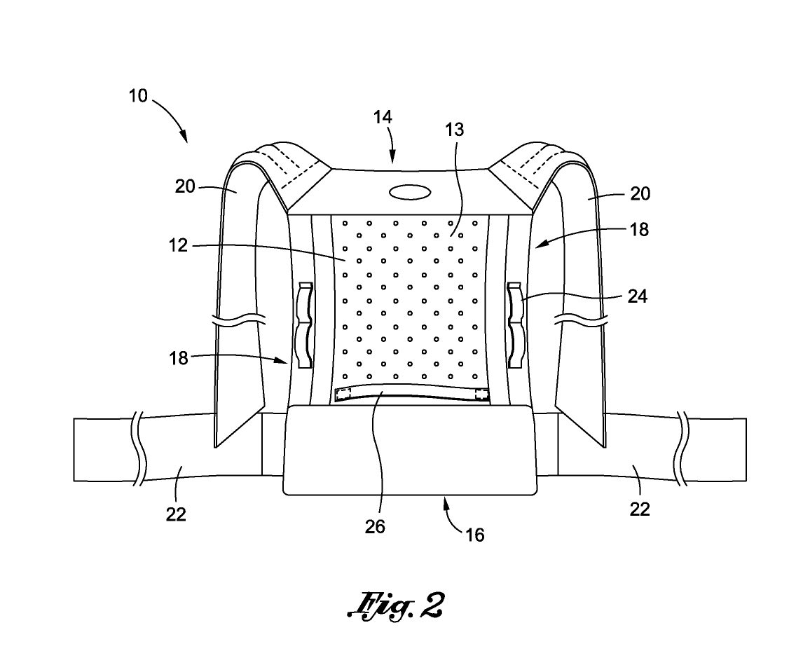

In order to prepare the infant carrier 10 for the “baby facing in” position, the parent holds the infant carrier 10 by waist straps 22, with each strap 22 in a different hand, and with the outer surface 13 of the main panel 12 facing toward the parent (see FIG. 3). The waist straps 22 are wrapped around the parent's waist and are tied together (see FIG. 4). The waist straps 22 may be tied in a tight double knot to secure the waist straps 22 to the parent. It is contemplated that other embodiments of the carrier 10 may include waist straps 22 that comprise mechanical fasteners (i.e., hook and loop fasteners) to couple the straps 22 (as opposed to tying the strap 22).

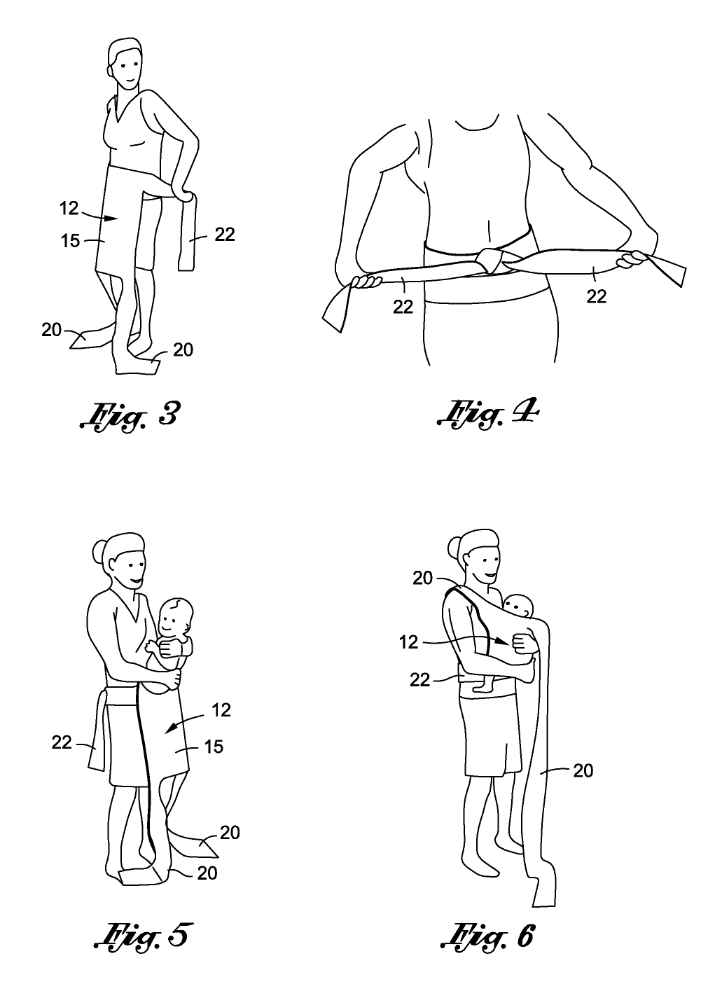

With the waist straps 22 tied, the parent grabs the child and holds the child facing the parent's body, i.e., with the child's chest facing the parent's chest, and with the child's back away from the parent (see FIG. 5). The child's legs should wrap comfortably around the parent's waist. With one hand securely on the child, the parent pulls the main panel 12 over the child's back and puts the shoulder straps 20 over the parent's shoulders (see FIG. 6). With the parent securely holding the child with one hand, the parent reaches behind his/her back to grab the shoulder straps 20 to form a crisscross pattern with the shoulder straps 20 on the parent's back (see FIG. 7). In particular, the shoulder strap 20 extending over the parent's right shoulder is pulled over the left side of the parent's waist. Conversely, the shoulder strap 20 extending over the left shoulder of the parent is pulled around the right side of the parent's waist.

When each shoulder strap 20 is pulled to the parent's waist, each strap 20 is fed through a respective leg hole loop 24 of a corresponding pair thereof and brought around the front of the parent's body (see FIG. 8). More particularly, each strap 20 is fed through a loop 24 of the pair that is diagonally opposed to the point of attachment of such strap 20 to the panel 12. In other words, the strap 20 extending from the upper left side of the panel 12 is fed through a loop 24 on the lower right side of the panel 12, and the strap 20 extending from the upper right side of the panel 12 is fed through a loop 24 on the lower left side of the panel 12. The infant carrier 10 may include a plurality of loops 24 on each side of the infant carrier 10 to accommodate both large and small children. The parent should feed the shoulder strap 20 through the loop 24 that creates a snug leg opening for the child. By doing so, the parent minimizes the risk that the child will fall out of the infant carrier 10 through the leg opening. Once this step is complete, the infant carrier 10 should provide a strap passing under each leg of the child (i.e., respective ones of the waist straps 22), as well as a strap passing over each leg of the child (i.e., respective ones of the shoulder strap 20) to secure the child within the carrier 10.

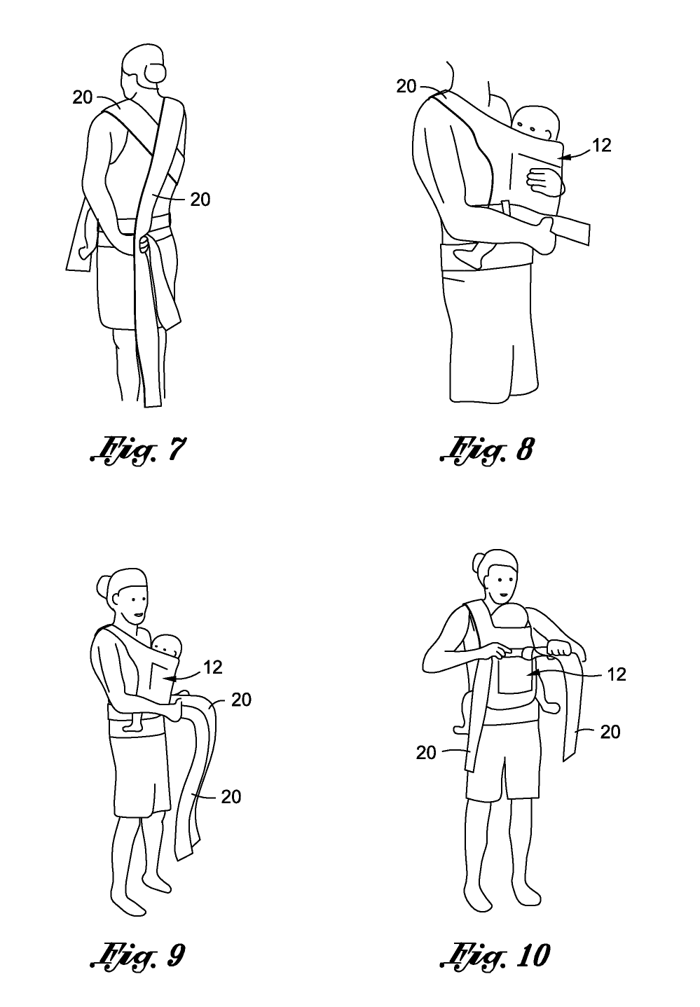

After both shoulder straps 20 have been fed through their respective loops 24, the ends of the shoulder straps 20 are pulled to bring the child to a comfortable position snuggly against the parent's body (see FIG. 9). The shoulder straps 20 are then tied across the baby's back and over the outer surface 13 of the panel 12 (see FIG. 10) to secure the carrier 10 to the parent, and to secure the child within the carrier 10. Other implementations of the carrier 10 may include shoulder straps 20 that comprise mechanical fasteners (i.e., hook and loop fasteners) to couple the straps 20 (rather than tying the straps 20).

Another position in which the parent and child may use the infant carrier 10 will be referred to herein as the “baby facing out” position, depicted in FIGS. 11-13. In the “baby facing out” position, the infant carrier 10 is worn with the main panel 12 disposed over the parent's chest, while the infant placed in the infant carrier 10 with the infant's head facing away from the parent and the infant's back directed toward the parent.

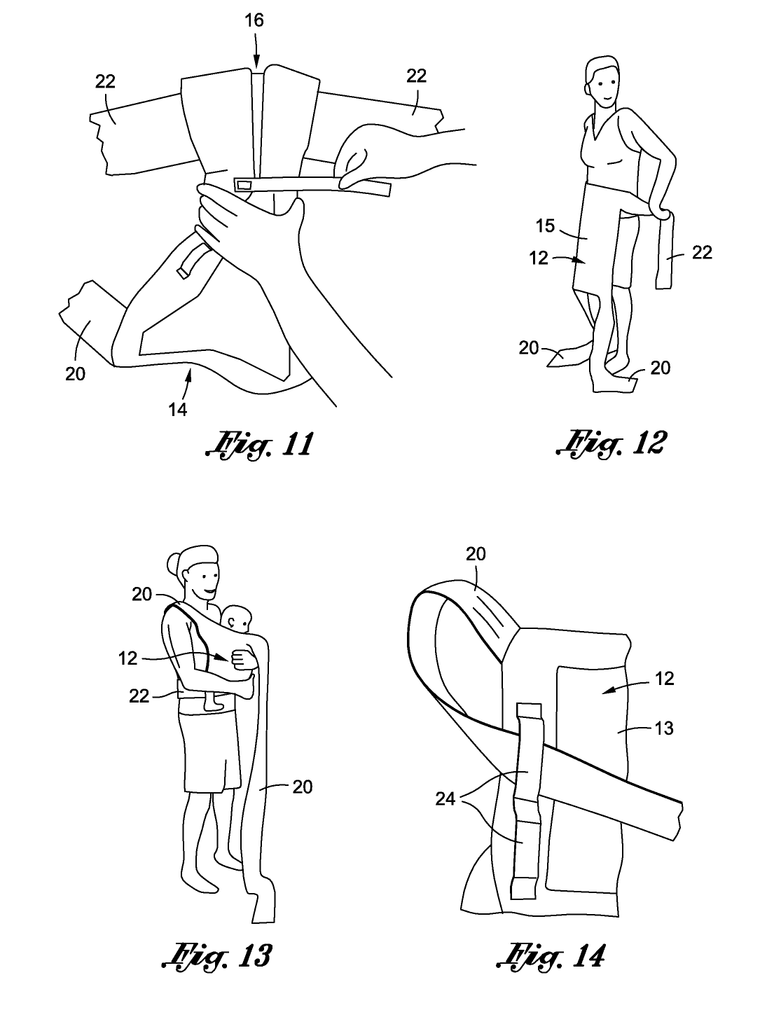

The infant carrier 10 is placed in the “baby facing out” position by cinching an area of the main panel 12 adjacent the lower end portion 16 by wrapping the adjustment strap 26 around the main panel 12 (see FIG. 11). The adjustment strap 26 may be configured to secure to itself by including hook and loop fasteners, snap fasteners, a button and loop, or other mechanical fasteners know by those skilled in the art. Then, with the outer surface 13 facing towards the parent's body, the waist straps 22 are wrapped around the parent's body and tied or otherwise fastened adjacent the parent's back (see FIG. 12). The parent then hold the baby over her chest, and pulls the main panel 12 over the baby's stomach and chest, with the parent ensuring that the child's legs are on opposing sides of the main panel 12 (see FIG. 13). The shoulder straps 20 are then placed over the parent's shoulders, and tied around the parent's waist, as described in more detail above, with the parent ensuring that each shoulder strap 20 is inserted in a respective, diagonally opposed loop 24 to create a snug leg opening for the infant (see FIGS. 7-10). In this regard, the waist strap 22 should pass under the child's legs, while the shoulder straps 20 should pass over the child's legs to minimize the risk of the child falling out of the infant carrier 10 through the leg hole.

Referring now to FIGS. 14-21, there is illustrated another position for the infant carrier 10, wherein the child is carried on the parent's back, referred to herein as the “baby on back” position. This position may be less invasive on the parent, as the infant would not be directly in front of the parent, and the baby on back position may give the child some desired independence. It may also be easier to carry the child in this position, as the parent may be used to carrying a backpack, or other similar luggage in a comparable position.

In order to configure the infant carrier 10 in the “baby on back” position, the free end of each shoulder strap 20 is inserted through a loop 24 to create a shoulder strap loop (see FIG. 14). Unlike the two positions discussed above, each shoulder strap 20 is inserted into a loop 24 located on the same side of the panel 12 as the strap 20. In other words, the strap 20 extending from the upper left side of the panel 12 is inserted in a loop 24 located on the lower left side of the panel 12, and the strap 20 extending from the upper right side of the panel 12 is inserted in a loop 24 located on the lower right side of the panel 12. The parent should choose the loop 24 that is over the child's leg and that creates a snug leg opening for the child.

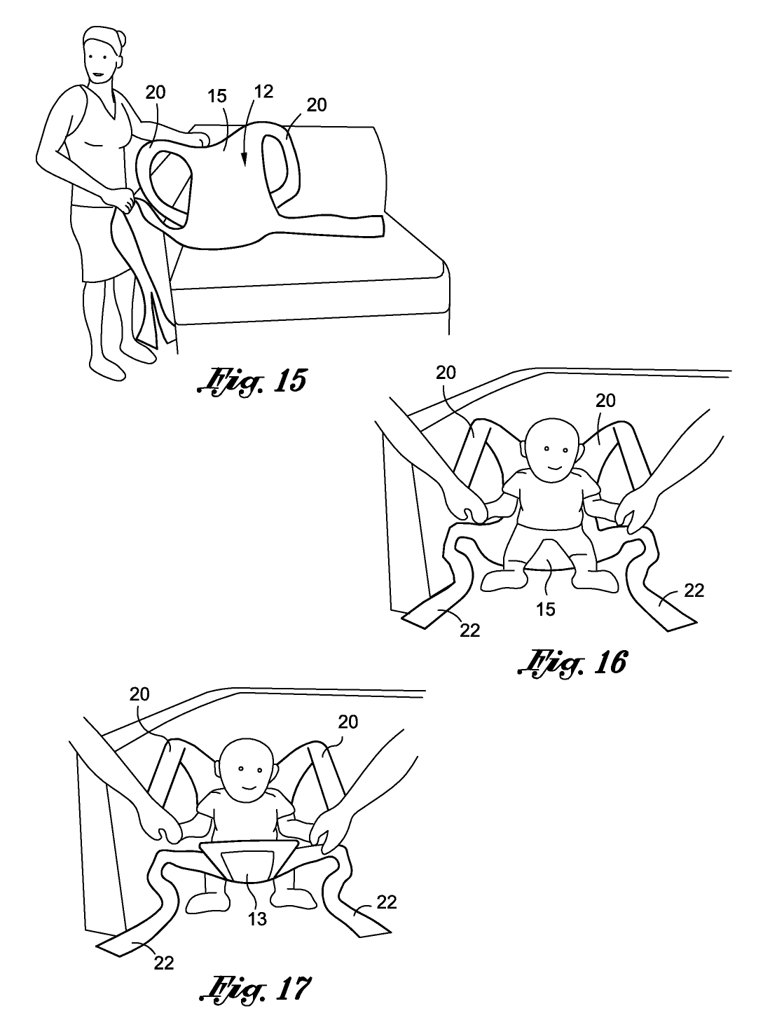

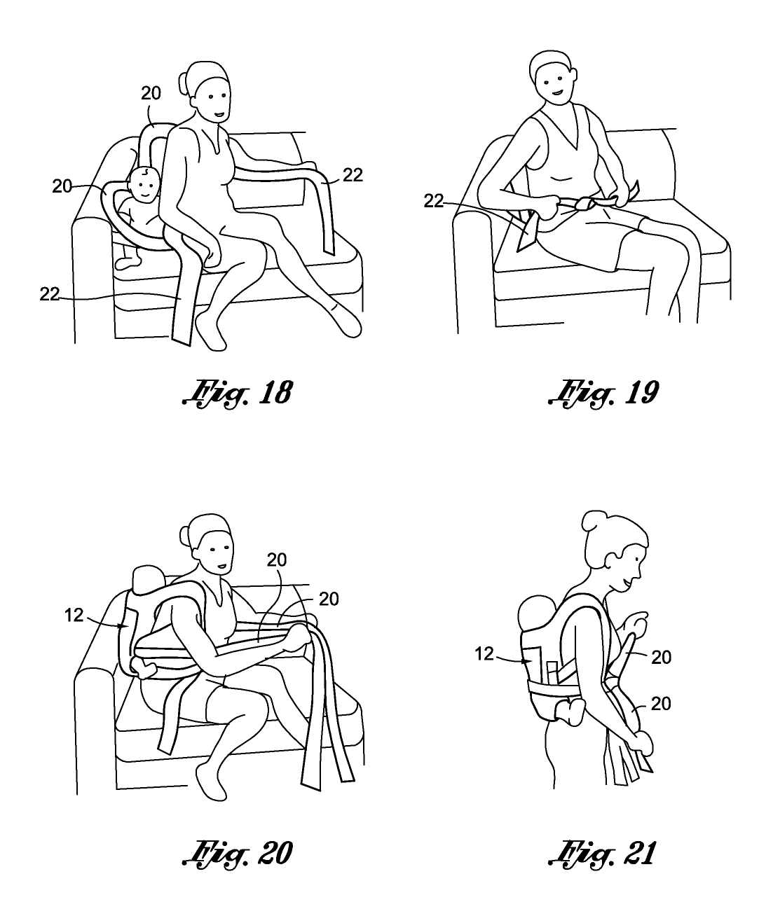

The infant carrier 10 is then placed in a secured corner (i.e., in a chair, couch, or the like), with the outer surface 13 facing toward the corner (see FIG. 15). The center of the main panel 12 should be placed near the lowest point of the corner. The infant is then seated on the center of main panel 12 in the corner (see FIG. 16). The main panel 12 is then folded up between the infant's legs against the infant's stomach and chest to create a seat (see FIG. 17). The parent then gently sits in front of the child close enough to wrap the child's legs around the parent's body (see FIG. 18). The waist straps 22 are then wrapped around the parent's body and secured, i.e., tied (see FIG. 19). With the waist straps 22 tied, the parent places his/her arms through the looped shoulder straps 20 and pulls the loose end of the shoulder straps 20 to tighten the child onto the parent's back (see FIG. 20). Once the parent feels that the child is secure, the parent stands up while continuing to hold the shoulder straps 20 tightly. The shoulder straps 20 are then crossed around the parent's back over the child, and brought around to the front of the parent and fastened, i.e., tied (see FIG. 21).

The infant carrier 10 may be deployed in any of the various positions described above. The parent may choose to switch the positions routinely. When the parent is done using the carrier 10 it may be rolled up for compact storage or travel.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. An infant carrier for use by a wearer for supporting an infant, the infant carrier comprising:
a main panel having an upper end portion, a lower end portion, and opposing lateral side portions;
a pair of waist straps connected to the lower end portion of the main panel adjacent respective ones of the lateral side portions, the waist straps being configured to be disposable about the wearer's waist and connectable to each other;
a first pair of loops connected to the main panel adjacent respective ones of the lateral side portions; and
a pair of shoulder straps connected to the upper end portion of the main panel adjacent respective ones of the lateral side portions, the shoulder straps being advanceable through respective ones of the first pair of loops to define respective looped configurations, the shoulder straps being connectable to each other;
the infant carrier being configured to be transitional between a front carry position wherein the infant is supported over the wearer's chest and a back carry position wherein the infant is supported over the wearer's back.

2. The infant carrier as recited in claim 1, wherein the pair of shoulder straps, the lower end portion of the main panel and the pair of waist straps collectively define a pair of leg openings when the pair of shoulder straps are advanced through the pair of loops.

3. The infant carrier as recited in claim 2, further comprising a second pair of loops connected to the main panel adjacent respective ones of the lateral side portions, each shoulder strap being advanceable through a respective one of the first pair of loops and the second pair of loops.

4. The infant carrier as recited in claim 3, wherein the second pair of loops is axially aligned with the first pair of loops.

5. The infant carrier as recited in claim 4, wherein the second pair of loops is disposed adjacent the first pair of loops.

6. The infant carrier as recited in claim 3, wherein the pair of shoulder straps, the lower end portion of the main panel and the pair of waist straps collectively define a pair of leg openings when each shoulder strap is advanced through the respective one of the first pair of loops and the second pair of loops.

7. The infant carrier as recited in claim 6, wherein the size of the pair of leg openings is selectively adjustable by selectively advancing each of the shoulder straps through the respective one of the first pair of loops and the second pair of loops.

8. The infant carrier as recited in claim 1, wherein the pair of waist straps are tieable to each other.

9. The infant carrier as recited in claim 1, wherein the pair of shoulder straps are advanceable through the diagonally opposed ones of the first pair of loops to support an infant over the wearer's chest.

10. The infant carrier as recited in claim 9, wherein the pair of shoulder straps are advanceable through the respective ones of the first pair of loops disposed on a common lateral portion as the respective ones of the pair of shoulders straps to support an infant over the wearer's back.

11. An infant carrier for use by a wearer for supporting an infant, the infant carrier comprising:
a main panel having an upper end portion, a lower end portion, and opposing lateral side portions;
a pair of waist straps connected to the lower end portion of the main panel adjacent respective ones of the lateral side portions, the pair of waist straps being configured to be disposable about the wearer's waist and connectable to each other; and
a pair of shoulder straps connected to the upper end portion of the main panel adjacent respective ones of the lateral side portions, the pair of shoulder straps being selectively connectable to discrete locations of the main panel to define respective looped configurations;
the infant carrier being configured to be transitional between a front carry position wherein the infant is supported over the wearer's chest and a back carry position wherein the infant is supported over the wearer's back.

12. The infant carrier as recited in claim 11, wherein the pair of shoulder straps, the lower end portion of the main panel and the pair of waist straps collectively define a pair of leg openings when the pair of shoulder straps are connected to the main panel.

13. The infant carrier as recited in claim 12, wherein the pair of shoulder straps are connectable to various locations on the main panel to adjust the size of the pair of leg openings.

14. The infant carrier as recited in claim 11, wherein the pair of waist straps are connectable to each other.

15. The infant carrier as recited in claim 14, wherein the pair of waist straps are tieable to each other.

16. The infant carrier as recited in claim 11, wherein the pair of shoulder straps are connectable to diagonally opposed locations of the main panel to support an infant over the wearer's chest.

17. The infant carrier as recited in claim 16, wherein the pair of shoulder straps are connectable to a common lateral portion of the main panel as the respective ones of the pair of shoulders straps to support an infant over the wearer's back.

18. An infant carrier for use by a wearer for supporting an infant, the infant carrier comprising:
a main panel having an upper end portion and an lower end portion;
a waist strap connected to the lower end portion of the main panel, the waist strap being configured to be disposable about the wearer's waist; and
a pair of shoulder straps, each shoulder strap having a first end portion connected to the upper end portion of the main panel and a second end portion connectable to the lower end portion of the main panel to define a respective looped configuration;
the infant carrier being configured to be transitional between a front carry position wherein the infant is supported over the wearer's chest and a back carry position wherein the infant is supported over the wearer's back.

19. The infant carrier as recited in claim 18, wherein the pair of shoulder straps, the lower end portion of the main panel and the waist strap collectively define a pair of leg openings when the pair of shoulder straps are connected to the main panel.

20. The infant carrier as recited in claim 19, wherein the pair of shoulder straps are connectable to various locations on the main panel to adjust the size of the pair of leg openings.
